(19) United States
(12) Patent Application Publication
(10) Pub. No.: US 2025/0392228 A1
(43) Pub. Date: Dec. 25, 2025

(54) Power Conversion Device

(71) Applicant: Hitachi Industrial Equipment Systems Co., Ltd., Chiyoda-ku, Tokyo (JP)

(72) Inventors: Fumihiro SATO, Tokyo (JP); Keisuke TANABE, Tokyo (JP); Koji HAMANO, Tokyo (JP); Hiroyoshi MIYAZAKI, Chiba (JP)

(21) Appl. No.: 18/876,228

(22) PCT Filed: Jun. 23, 2023
(86) PCT No.: PCT/JP2023/023297

§ 371 Date: Dec. 18, 2024

(30) Foreign Application Priority Data
Dec. 19, 2022 (JP) 2022-202073

(51) Int. Cl. H02M 5/458; H02M 7/00

(52) U.S. Cl. CPC H02M 5/458; H02M 7/003

(57) ABSTRACT

To provide a power conversion device capable of making miniaturization and a stable operation compatible with each other. Therefore, a smoothing capacitor 21 outputs a high-side potential of a DC voltage, and a smoothing capacitor 22 is connected in series with the smoothing capacitor 21 and outputs a low-side potential of the DC voltage. An inverter circuit 103 converts the DC voltage output from the smoothing capacitors 21 and 22 into an AC voltage. A control circuit 104 controls the inverter circuit 103. The inverter circuit 103 is mounted on a main circuit board 61. Each of the smoothing capacitors 21 and 22 is arranged such that an axial direction, which defines its longest size, is substantially parallel to a plane direction of the main circuit board 61. The smoothing capacitor 21 is arranged at a position farther away from the control circuit 104 than the smoothing capacitor 22.

### TECHNICAL FIELD

The present invention relates a power conversion device, and relates, for example, to a power conversion device that supplies AC power to a load of a motor or the like.

### BACKGROUND ART

A motor driving power conversion device generally includes a rectifier part that converts an AC voltage to a DC voltage, a smoothing capacitor that smooths the DC voltage, and an inverter circuit that inversely converts the DC voltage into the AC voltage. As the rectifier part, two types of circuit systems are mainly used depending on a voltage value of the AC voltage. A full-wave rectifier circuit is used when the AC voltage is more than 200 V and a voltage doubler rectifier circuit is used when the AC voltage is about 100 V to 120 V. When the voltage doubler rectifier circuit is used, a DC voltage that is about twice a peak value of the AC voltage can be obtained.

As a configuration in which the two types of circuit systems, that is, the full-wave rectifier circuit and the voltage doubler rectifier circuit are used in combination, Patent Document 1 describes a motor driving power conversion device that switches full-wave rectification and voltage doubler rectification depending on a rotational speed of a motor.

### RELATED ART DOCUMENT

### Patent Document

Patent Document 1: Japanese Patent Application Laid-Open Publication No. 2003-319676

### SUMMARY OF THE INVENTION

### Problems to be Solved by the Invention

The power conversion device illustrated in Patent Document 1 operates a voltage doubler rectifier circuit by rendering a switch illustrated in FIG. 1 in Patent Document 1 conductive. As illustrated in FIG. 1, the voltage doubler rectifier circuit includes a first electrolytic capacitor connected between a high-side potential node of a DC voltage and an AC power source and a second electrolytic capacitor connected between the AC power source and a low-side potential node of the DC voltage. In addition, FIG. 7 in Patent Document 1 describes a positional relationship between an inverter circuit and the first and second electrolytic capacitors. The first and second electrolytic capacitors are mounted on a substrate on which the inverter circuit is mounted such that a height direction of the first and second electrolytic capacitors is a direction perpendicular to a substrate plane.

The voltage doubler rectifier circuit charges the electrolytic capacitor only within either one of positive and negative half cycles of an AC voltage due to a principle of operation. Accordingly, when the voltage doubler rectifier circuit is used, a ripple current may be larger than that when the full-wave rectifier circuit, which charges the electrolytic capacitor in either half cycle of the AC voltage whether positive or negative, is used. With this, when electrolytic capacitors having the same capacitance are respectively applied to the full-wave rectifier circuit and the voltage doubler rectifier circuit having the same output capacitance, heat generation by the electrolytic capacitor tends to more increase in the voltage doubler rectifier circuit. Accordingly, when comparison is made between the rectifier circuits having the same output capacitance, the capacitance of the electrolytic capacitor used in the voltage doubler rectifier circuit is generally designed to be larger than the capacitance of the electrolytic capacitor used in the full-wave rectifier circuit.

Note that the withstand voltage of the electrolytic capacitor used in the voltage doubler rectifier circuit can be reduced to a half of that of the electrolytic capacitor used in the full-wave rectifier circuit. However, depending on the specifications of the power conversion device, an amount of increase in the volume of the electrolytic capacitor due to the above-described increase in the capacitance may be larger than an amount of decrease in the volume of the electrolytic capacitor due to this reduction in the withstand voltage. Generally, the larger the capacitance is, the larger a radial direction or a height direction of the electrolytic capacitor becomes. Accordingly, when the electrolytic capacitor is mounted in a direction illustrated in Patent Document 1 in the power conversion device including the voltage doubler rectifier circuit, the size of the power conversion device may increase due to an increase in size in the radial direction or the height direction of the electrolytic capacitor and an increase in a substrate area by separately arranging a smoothing capacitor.

In addition, a case potential of an electrolytic capacitor is generally an indeterminate potential between a negative electrode terminal potential and a positive electrode terminal potential. Accordingly, if a wiring of a weak electric signal generated with a low-side potential of a DC voltage used as a reference, such as a current detection signal or a gate signal in an inverter circuit, is close to a first electrolytic capacitor that outputs a high-side potential of the DC voltage, for example, a high potential difference occurs between the case potential and a potential of the weak electric signal. As a result, large noise is superimposed on the weak electric signal, whereby a malfunction may occur. Then, the smaller the size of the power conversion device becomes, the more significant a problem of this malfunction may be.

The present invention has been made in view of such circumstances, and has as its object to provide a power conversion device capable of making miniaturization and a stable operation compatible with each other.

The above and other objects and novel features of the present invention will be apparent from the description of the present specification and the accompanying drawings.

### Means for Solving the Problems

A power conversion circuit according to one embodiment includes first and second capacitors, an inverter circuit, a control circuit, and a first substrate. The first capacitor outputs a high-side potential of a DC voltage, and the second capacitor is connected in series with the first capacitor and outputs a low-side potential of the DC voltage. The inverter circuit converts the DC voltage output from the first capacitor and the second capacitor into an AC voltage. The control circuit controls the inverter circuit. The inverter circuit is mounted on the first substrate. Each of the first and second capacitors is arranged such that an axial direction, which defines its longest size, is substantially parallel to a plane direction of the first substrate. The first capacitor is arranged at a position farther away from the control circuit than the second capacitor.

### Effects of the Invention

When effects obtained by a typical embodiment in the invention disclosed in the present application will be briefly described, both miniaturization and a stable operation can be made compatible with each other in a power conversion device.

### BRIEF DESCRIPTIONS OF THE DRAWINGS

FIG. 1 is a circuit diagram illustrating a schematic configuration example of a power conversion device according to a first embodiment.

FIG. 2 is a circuit diagram illustrating a configuration example of a control circuit in FIG. 1.

FIG. 3 is a bird's-eye view illustrating an example of an outer shape of the power conversion device illustrated in FIG. 1.

FIG. 4 is a side view, viewed in another direction, of the power conversion device illustrated in FIG. 3.

FIG. 5 is a bird's-eye view illustrating an example of an outer shape different from that in FIG. 3 in a power conversion device according to a second embodiment.

FIG. 6 is a side view, viewed in another direction, of the power conversion device illustrated in FIG. 5.

FIG. 7 is a diagram illustrating an example of a method for physically fixing a capacitor board to a main circuit board.

FIG. 8 is a bird's-eye view illustrating an example of an outer shape different from that in FIG. 5 in a power conversion device according to a third embodiment.

FIG. 9 is a side view, viewed in another direction, of the power conversion device illustrated in FIG. 8.

FIG. 10 is a bird's-eye view illustrating an example of an outer shape different from that in FIG. 8 in a power conversion device according to a fourth embodiment.

### DETAILED DESCRIPTION OF PREFERRED EMBODIMENTS

Embodiments of the present invention will be described in detail below with reference to the drawings. Note that in all the drawings for describing the embodiments, the same members are respectively denoted by the same reference numerals in principal, and description thereof is not repeated.

### First Embodiment

### <Circuit Configuration of Power Conversion Device>

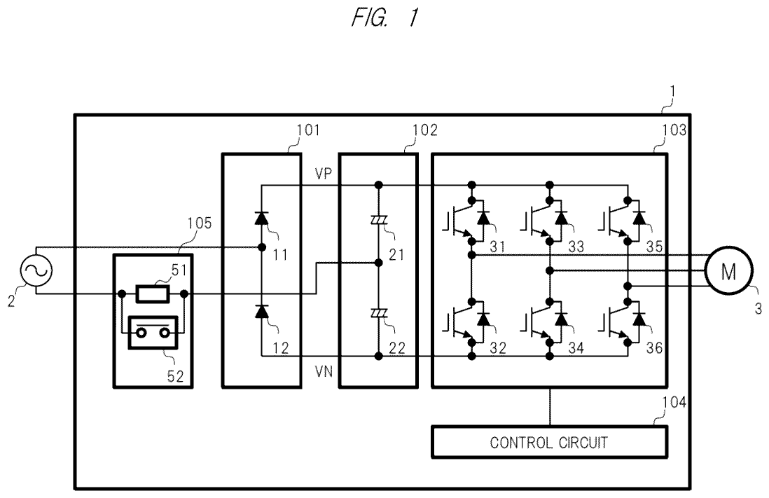

FIG. 1 is a circuit diagram illustrating a schematic configuration example of a power conversion device according to a first embodiment. A power conversion device 1 illustrated in FIG. 1 includes a rectifier circuit 101, a smoothing capacitor unit 102, an inverter circuit 103, a control circuit 104, and an inrush current limiting circuit 105. The smoothing capacitor unit 102 includes a smoothing capacitor (first capacitor) 21 that outputs a high-side potential VP of a DC voltage and a smoothing capacitor (second capacitor) 22 that is connected in series with the smoothing capacitor 21 and outputs a low-side potential VN of the DC voltage.

The rectifier circuit 101 rectifies an external AC voltage 2 using diodes 11 and 12, and charges the smoothing capacitors 21 and 22 in the smoothing capacitor unit 102 at DC voltage obtained by the rectification. The smoothing capacitor unit 102 smooths the DC voltage input from the rectifier circuit 101. The inverter circuit 103 converts the DC voltage output from the smoothing capacitor unit 102 into an AC voltage. The control circuit 104 controls the inverter circuit 103.

The rectifier circuit 101 and the smoothing capacitor unit 102 that are connected to each other as illustrated in FIG. 1 are generally referred to as a voltage doubler rectifier circuit. The diode 11 is rendered conductive so that the smoothing capacitor 21 is charged in a positive half cycle of the AC voltage 2, and the diode 12 is rendered conductive so that the smoothing capacitor 22 is charged in a negative half cycle of the AC voltage 2.

As a result of the smoothing capacitors 21 and 22 being thus alternately charged, if an effective value of the AC voltage 2 is 100 V, for example, a both-end voltage of each of the smoothing capacitors 21 and 22 is about 141 V as a peak voltage of the AC voltage 2. Thus, a DC voltage output from the smoothing capacitor unit 102, i.e., a voltage of the high-side potential VP with the low-side potential VN used as a reference is about 282 V as a total value of the respective both-end voltages of the smoothing capacitors 21 and 22.

Various capacitors such as a film capacitor and a ceramic capacitor are applicable to the smoothing capacitors 21 and 22 to be applied to the power conversion device 1. However, an electrolytic capacitor may be used in many cases for the smoothing capacitors 21 and 22 from the viewpoint of smoothing a DC voltage by a large capacitance and the viewpoint of obtaining a high withstand voltage. Therefore, in the embodiment, the smoothing capacitors 21 and 22 will be mainly described as being an electrolytic capacitor.

The inverter circuit 103 includes switching elements 31 to 36, and outputs AC power to a motor 3 as an example of a load. Although composed of an IGBT as a typical example, each of the switching elements 31 to 36 illustrated in FIG. 1 may be composed of other power semiconductor transistors such as a MOSFET. The control circuit 104 detects a current flowing through the motor 3 and the switching elements 31 to 36, and outputs a driving signal to the switching elements 31 to 36 such that the motor 3 performs a desired operation.

The inrush current limiting circuit 105 includes a current limiting resistor 51 and a relay 52, and is provided for the purpose of limiting a charging current to the smoothing capacitors 21 and 22, i.e., a large inrush current when the AC voltage 2 is turned on. If a potential difference between the high-side potential VP and the low-side potential VN of the DC voltage is lower than a predetermined value, for example, immediately after the AC voltage 2 is turned on, the relay 52 is controlled to an off state. As a result, the smoothing capacitors 21 and 22 are charged at a current limited by the current limiting resistor 51. Thereafter, when the smoothing capacitors 21 and 22 are charged to a predetermined voltage value or more, the relay 52 is controlled to an on state. Note that the relay 52 can be replaced with another element such as a thyristor.

As previously described, the smoothing capacitor 21 is charged in the positive half cycle of the AC voltage 2, and the smoothing capacitor 22 is charged in the negative half cycle of the AC voltage 2. Therefore, assuming that the relay 52 is in the on state, the smoothing capacitor 21 smooths an area between the high-side potential VP of the DC voltage and the AC voltage 2, and the smoothing capacitor 22 smooths an area between the AC voltage 2 and the low-side potential VN of the DC voltage.

Generally, a case potential of the electrolytic capacitor is an indeterminate potential between a negative electrode terminal potential and a positive electrode terminal potential of the electrolytic capacitor. Accordingly, a case potential of the smoothing capacitor 21 has a magnitude between the high-side potential VP of the DC voltage and the AC voltage 2, and a case potential of the smoothing capacitor 22 has a magnitude between the AC voltage 2 and the low-side potential VN of the DC voltage. As an example, if the DC voltage is 282 V, the case potential of the smoothing capacitor 22 is a value between 0 V and 141 V and the case potential of smoothing capacitor 21 is a value between 141 V and 282 V when the low-side potential VN of the DC voltage is used as a reference.

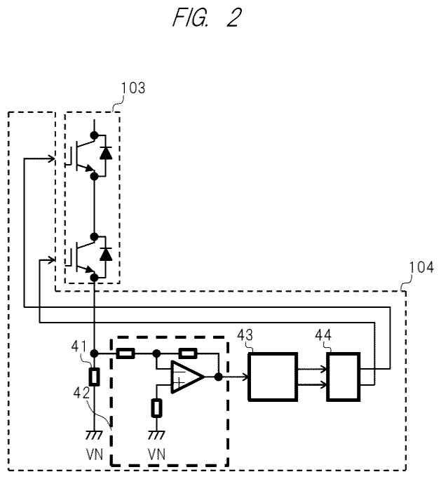

FIG. 2 is a circuit diagram illustrating a configuration example of the control circuit 104 in FIG. 1. The control circuit 104 illustrated in FIG. 2 includes a current detection resistor 41, an amplifier circuit 42, a microcontroller 43, and a gate driver 44. The current detection resistor 41 converts a current flowing through the inverter circuit 103 into a voltage signal of up to about 1 V, for example, and outputs the voltage signal to the amplifier circuit 42. The amplifier circuit 42 amplifies the input voltage signal to about several volts and outputs it as a current detection signal to the microcontroller 43.

The microcontroller 43 outputs a driving signal of about several volts to the gate driver 44 based on the input current detection signal. The gate driver 44 outputs a gate signal of about ten and several volts to the inverter circuit 103, for example, based on the driving signal from the microcontroller 43. The amplifier circuit 42 and the microcontroller 43 operate by a power supply voltage of about several volts with the low-side potential VN of the DC voltage used as a reference, for example, although illustration thereof is omitted.

In this way, the inverter circuit 103 is a strong electric part that handles a voltage of about 282 V with the low-side potential VN of the DC voltage used as a reference, while the control circuit 104 is a weak electric part that handles a voltage of about several volts to ten and several volts with the low-side potential VN of the DC voltage used as a reference. Note that a power supply operates voltage that the microcontroller 43 and the gate driver 44 is separately generated by a power supply circuit not illustrated, for example.

### <Outer Shape of Power Conversion Device>

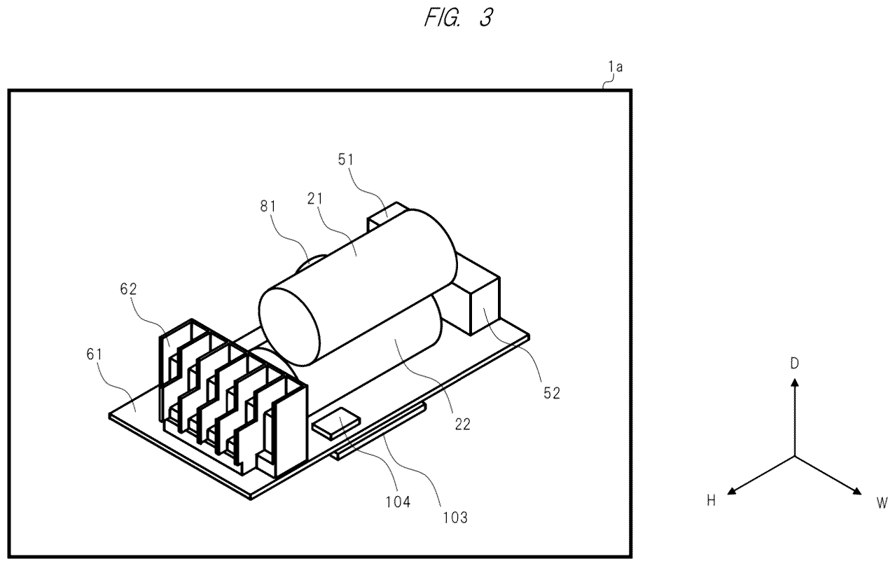

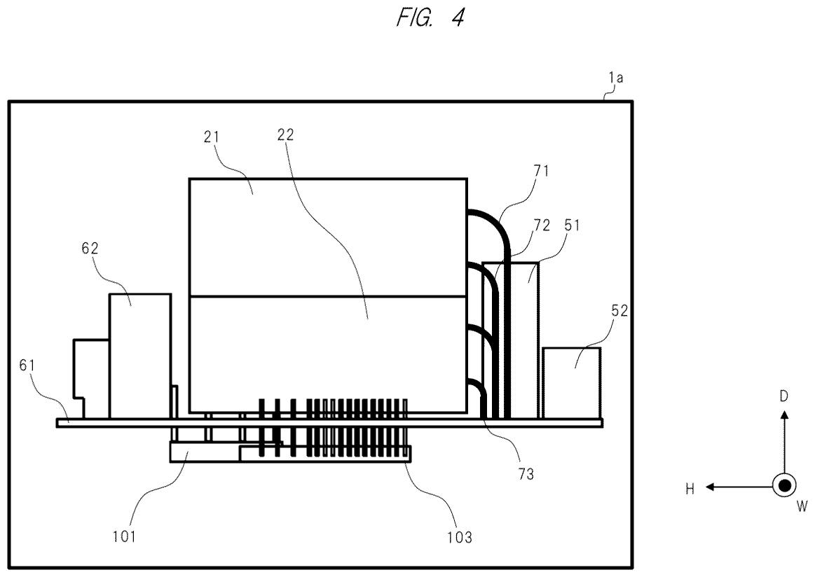

FIG. 3 is a bird's-eye view illustrating an example of an outer shape of the power conversion device illustrated in FIG. 1, and FIG. 4 is a side view, viewed in another direction, of the power conversion device illustrated in FIG. 3. In a power conversion device 1a illustrated in FIGS. 3 and 4, a main circuit board (first substrate) 61, a main circuit terminal block 62, electric wires 71 to 73, and an overvoltage protection element 81 are added as main large components to the configuration example illustrated in FIG. 1. In addition, in FIGS. 3 and 4, directions perpendicular to one another are respectively a width direction W, a depth direction D, and a height direction H, and a plane direction defined by the width direction W and the height direction H is defined as a plane direction of the main circuit board 61. FIG. 4 illustrates an example of an outer shape in a case where a plane defined by the depth direction D and the height direction H is set as a side surface.

The rectifier circuit 101, the inverter circuit 103, the control circuit 104, the current limiting resistor 51, the relay 52, the main circuit terminal block 62, and the overvoltage protection element 81 are mounted on the main circuit board (first substrate) 61. These are appropriately connected to one another via a wiring pattern on the main circuit board 61. The main circuit terminal block 62 is provided with terminals for energizing a main circuit current, such as an input terminal of the AC voltage 2 and an output terminal to the motor 3. One side of the AC voltage 2 input to the main circuit terminal block 62 is transmitted to the rectifier circuit 101 via the wiring pattern on the main circuit board 61 and the other side thereof is transmitted to the current limiting resistor 51 and the relay 52, i.e., the inrush current limiting circuit 105.

In the main circuit board 61, a node of the high-side potential VP of the DC voltage output from the rectifier circuit 101, a node of the low-side potential VN thereof, and an output node of the inrush current limiting circuit 105 are connected to respective positive electrode terminals and negative electrode terminals of the smoothing capacitors 21 and 22 via the electric wires 71 to 73. Specifically, the node of the high-side potential VP in the main circuit board 61 is connected to the positive electrode terminal of the smoothing capacitor 21 via the electric wire 71. The node of the low-side potential VN in the main circuit board 61 is connected to the negative electrode terminal of the smoothing capacitor 22 via the electric wire 73. The output node of the inrush current limiting circuit 105 and thus a node on the negative side of the AC voltage 2 is commonly connected to the negative electrode terminal of the smoothing capacitor 21 and the positive electrode terminal of the smoothing capacitor 22 via the electric wire 72.

In addition, in the main circuit board 61, the node of each of the high-side potential VP and the low-side potential VN of the DC voltage is also connected to the inverter circuit 103 via the wiring pattern on the main circuit board 61. A three-phase AC voltage output from the inverter circuit 103 is transmitted to the main circuit terminal block 62 via the wiring pattern on the main circuit board 61. The control circuit 104 is mounted on the main circuit board 61, and is connected to the node of the low-side potential VN of the DC voltage, the inverter circuit 103, and a node of a power supply voltage not illustrated via the wiring pattern on the main circuit board 61, as illustrated in FIG. 2 in this example.

The overvoltage protection element 81 is provided for the purpose of protecting a semiconductor element from a high voltage of static electricity or the like. As an example, the overvoltage protection element 81 is a varistor element or the like to be connected between the high-side potential VP and the low-side potential VN of the DC voltage or between lines of the AC voltage 2 for the purpose of protecting the diodes 11 and 12 in the rectifier circuit 101.

Here, in Patent Document 1, for example, each of the smoothing capacitors 21 and 22 is arranged on the main circuit board 61 such that an axial direction, which defines its longest size, is a direction substantially perpendicular to a plane of the main circuit board 61. Particularly, when an electrolytic capacitor including a positive electrode terminal and a negative electrode terminal on the same surface is used, as illustrated in FIG. 4, such an arrangement may be normally made. However, in this case, if the longest size of each of the smoothing capacitors 21 and 22 increases, a size in the depth direction D in FIG. 3 increases so that the power conversion device may increase in size.

Therefore, in the power conversion device 1a illustrated in FIGS. 3 and 4, each of the smoothing capacitors 21 and 22 is arranged such that the axial direction, which defines the longest size, the height direction H in this example is substantially parallel to a plane direction of the main circuit board 61. This makes it possible to suppress an increase in the size in the depth direction D in FIG. 3 and makes it possible to implement miniaturization of the power conversion device 1a.

Further, the smoothing capacitor 21 that outputs the high-side potential VP is arranged at a position farther away from the control circuit 104 than the smoothing capacitor 22 that outputs the low-side potential VN. In this example, the control circuit 104 is mounted on the main circuit board 61. Accordingly, the smoothing capacitor 21 is arranged at a position farther away from the main circuit board 61 than the smoothing capacitor 22. Specifically, in this example, the smoothing capacitor 21 is stacked and mounted on the smoothing capacitor 22 in the depth direction D.

As described above, the case potential of the smoothing capacitor 21 has a magnitude between the high-side potential VP of the DC voltage and the AC voltage 2, and the case potential of the smoothing capacitor 22 has a magnitude between the AC voltage 2 and the low-side potential VN of the DC voltage. Therefore, when the weak electric part, which operates with the low-side potential VN of the DC voltage used as a reference, such as the control circuit 104 is close to the smoothing capacitor 21, a potential difference of at least about 141 V may occur in a space between the weak electric part and the case of the smoothing capacitor 21. As a result, large noise is propagated from the smoothing capacitor 21 to the weak electric part, which may cause a malfunction of the control circuit 104 or the like.

Therefore, it is beneficial to arrange the smoothing capacitor 21 at an appropriate distance in the depth direction D away from the main circuit board 61, as illustrated in FIGS. 3 and 4. This makes it possible to prevent the malfunction of the control circuit 104 or the like and makes it possible to implement a stable operation in addition to the above-described miniaturization of the power conversion device 1. Note that each of the smoothing capacitors 21 and 22 includes the positive electrode terminal and the negative electrode terminal on the same surface here, but in some cases may include the positive electrode terminal on one of two opposite surfaces and the negative electrode terminal on the other surface. In this case, in FIG. 4, for example, a configuration in which the electric wires 71 and 73 are respectively connected to the right sides of the smoothing capacitors 21 and 22 and the electric wire 72 is connected to the left sides thereof is obtained.

In addition, although FIGS. 3 and 4 illustrate an example in which the smoothing capacitors 21 and 22 are stacked and mounted in the depth direction D, the arrangement of the smoothing capacitors 21 and 22 may be appropriately changed as long as the smoothing capacitor 21 is arranged at a position farther away from the control circuit 104 than the smoothing capacitor 22. However, if the control circuit 104, the smoothing capacitor 22, and the smoothing capacitor 21 are arranged in order in the width direction W in FIG. 3, for example, the area of the main circuit board 61 may increase. On the other hand, the area of the main circuit board 61 may be constrained for convenience of an application destination of the power conversion device 1. From this viewpoint, the smoothing capacitors 21 and 22 are desirably arranged in the depth direction D.

Further, a system according to the first embodiment is applicable not only to a single-phase voltage doubler also rectifier circuit but also to other circuits such as a three-phase full-wave rectifier circuit if it has a configuration in which the smoothing capacitors 21 and 22 are connected in series. As an example, the system may also be applied to a configuration in which one smoothing capacitor with 400 V withstand voltage specifications is replaced with two smoothing capacitors with 200 V withstand voltage specifications connected in series from the viewpoint of easily securing a withstand voltage in the three-phase full-wave rectifier circuit. In this case, in FIG. 4, the electric wire 72 need not be connected to the main circuit board 61, although it connects the negative electrode terminal of the smoothing capacitor 21 and the positive electrode terminal of smoothing capacitor 22 to each other.

In addition, the smoothing capacitors 21 and 22 may be fixed to the main circuit board 61 using various systems, although illustration thereof is omitted. Examples include a system for forming each of the electric wires 71 to 73 of a highly rigid copper bar or the like. Alternatively, examples include a system for fixing the main circuit board 61 and the smoothing capacitor 22 to each other and fixing the smoothing capacitor 22 and the smoothing capacitor 21 to each other, respectively, with bonding members. Alternatively, examples include a system for using a cover member not illustrated that houses the power conversion device 1a to define a shape of the cover member such that the smoothing capacitors 21 and 22 can be fixed thereto and a system for attaching a holder for fixing the smoothing capacitors 21 and 22 to the cover member.

### Main Effects of First Embodiment

In the foregoing, in the system according to the first embodiment, each of the smoothing capacitors 21 and 22 is arranged such that the axial direction, which defines the longest size thereof, is substantially parallel to the plane direction of the main circuit board 61, and the smoothing capacitor 21 that outputs the high-side potential VP is arranged at a position farther away from the control circuit 104 than the smoothing capacitor 22 that outputs the low-side potential VN. This makes it possible to make miniaturization and a stable operation compatible with each other in each of the power conversion device 1 and 1a.

### Second Embodiment

### <Outer Shape of Power Conversion Device>

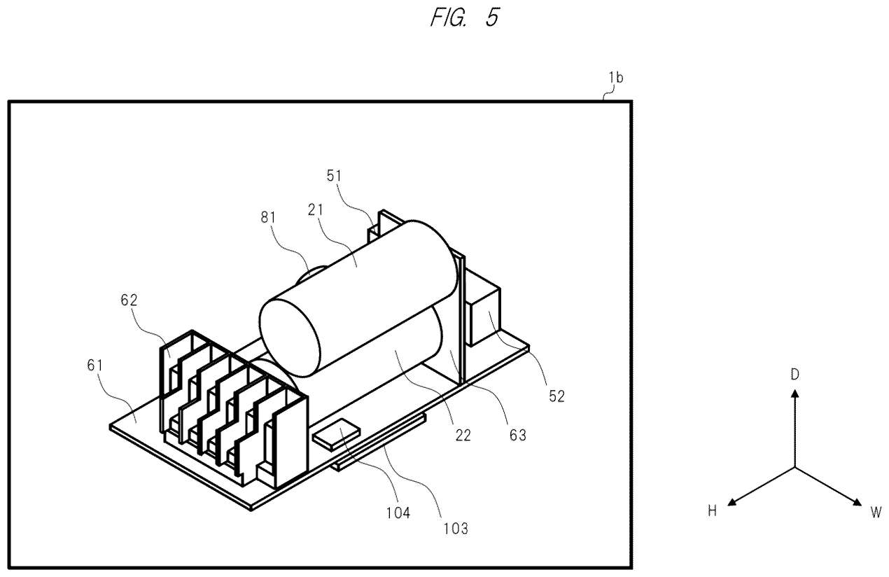

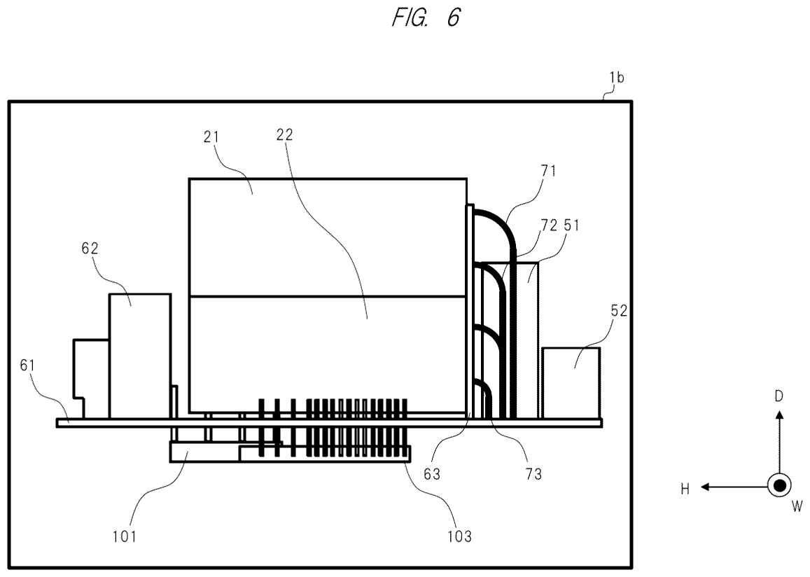

FIG. 5 is a bird's-eye view illustrating an example of an outer shape different from that in FIG. 3 in a power conversion device according to a second embodiment, and FIG. 6 is a side view, viewed in another direction, of the power conversion device illustrated in FIG. 5. In a power conversion device 1b illustrated in FIGS. 5 and 6, a capacitor board (second substrate) 63 is added to the configuration example illustrated in FIG. 3. The capacitor board 63 is arranged with a direction substantially perpendicular to a plane of a main circuit board 61 used as a plane direction. That is, the plane direction of the capacitor board 63 is a plane direction defined by a width direction W and a depth direction D.

In the configuration example illustrated in FIGS. 3 and 4, the smoothing capacitors 21 and 22 are connected to the main circuit board 61 via only the electric wires 71 to 73. Therefore, in order to fix the smoothing capacitors 21 and 22 to the main circuit board 61 using the configuration example illustrated in FIGS. 3 and 4, any contrivance for applying a copper bar or the like to the electric wires 71 to 73, for example, has been required.

On the other hand, in FIGS. 5 and 6, the capacitor board 63 is provided, and smoothing capacitors 21 and 22 are mounted on the capacitor board 63. The capacitor board 63 includes through holes for connection of the smoothing capacitors 21 and 22, and the smoothing capacitors 21 and 22 are fixed to the capacitor board 63 by being connected to the through holes with solder or the like.

Each of the electric wires 71 to 73 has its one end connected to the through hole provided in the capacitor board 63 with solder or the like and its other end connected to a through hole provided in the main circuit board 61 with solder or the like. Thus, the smoothing capacitors 21 and 22 are physically fixed to the main circuit board 61 via the capacitor board 63. In addition, respective positive electrode terminals and negative electrode terminals of the smoothing capacitors 21 and 22 are electrically connected to the main circuit board 61 via the capacitor board 63 and the electric wires 71 to 73.

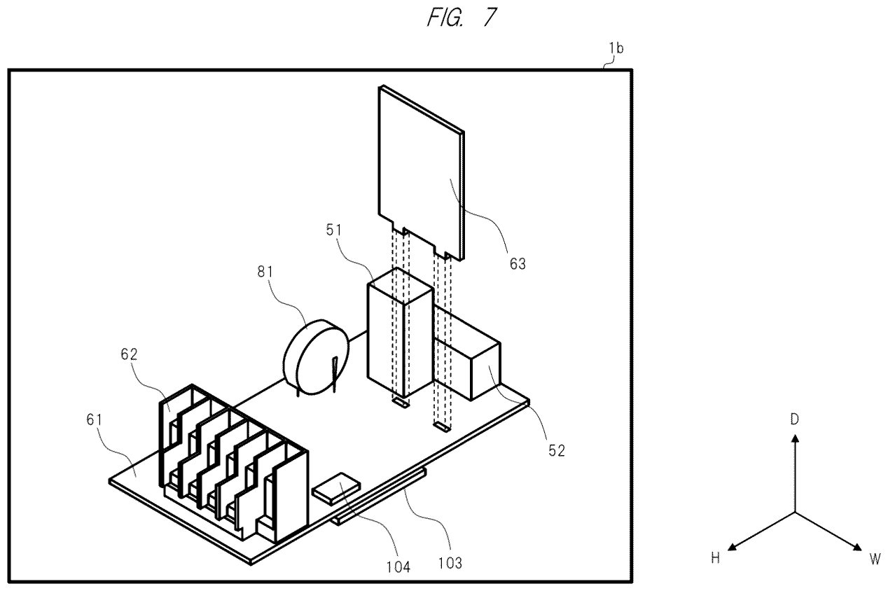

FIG. 7 is a diagram illustrating an example of a method for physically fixing the capacitor board 63 to the main circuit board 61. Note that in FIG. 7, the smoothing capacitors 21 and 22 are not illustrated to clearly indicate a contact portion between the boards. As illustrated in FIG. 7, a protrusion is formed to protrude in the depth direction D in an end portion of the capacitor board 63. On the other hand, an opening, which is fitted in the protrusion in the capacitor board 63, is formed in the main circuit board 61.

As illustrated in FIG. 7, the protrusion provided in the capacitor board 63 is fitted in the opening provided in the main circuit board 61, thereby making it possible to make the capacitor board 63 self-standing with respect to the main circuit board 61. In addition, a positional relationship between the capacitor board 63 and the main circuit board 61 is fixedly defined. Accordingly, respective positions of the smoothing capacitors 21 and 22 relative to the main circuit board 61 are also fixedly defined.

Here, the power conversion device 1b illustrated in FIGS. 5 to 7 is assembled in the following procedure, for example. First, the respective one ends of the electric wires 71 to 73 are soldered to the capacitor board 63. Then, the smoothing capacitors 21 and 22 are mounted on the capacitor board 63. Thereafter, the capacitor board 63 is attached to the main circuit board 61, and the respective other ends of electric wires 71 to 73 are soldered to the main circuit board 61. In this case, a mechanism capable of inserting the capacitor board 63 into the main circuit board 61 is used, as illustrated in FIG. 7, whereby a series of assembly processes including positioning can be facilitated.

Note that the capacitor board 63 is used as means for physically fixing the smoothing capacitors 21 and 22 to the main circuit board 61 here, but, in addition, the capacitor board 63 can also be used as electrical connection means. Specifically, for example, a slot including an electrical terminal is mounted on the main circuit board 61, and an electrical terminal, which is connected to each of the positive electrode terminals and the negative electrode terminals of the smoothing capacitors 21 and 22 via a wiring pattern, is formed in an end portion of the capacitor board 63. The end portion of the capacitor board 63 is inserted into the slot of the main circuit board 61. Thus, the capacitor board 63 and the main circuit board 61 are physically fixed to each other and are also electrically connected to each other.

However, in this case, a relatively large slot corresponding to a large current needs to be provided in the main circuit board 61. In this case, a large mounting region of the slot needs to be secured on the main circuit board 61, and further a component cost of the slot is also required. On the other hand, when a system illustrated in FIGS. 5 to 7 is used, the mounting region of the slot is not required, and further the component cost of the slot is not required either.

### Main Effects of Second Embodiment

From the foregoing, the system according to the second embodiment is used, whereby similar effects to the various types of effects described in the first embodiment are obtained. Further, the capacitor board 63 is provided, whereby the component cost may more increase e than that in the system according to the first embodiment. However, it is easy to physically fix the smoothing capacitors 21 and 22 to the main circuit board 61 and it is also possible to facilitate an assembly process.

### Third Embodiment

### <Outer Shape of Power Conversion Device>

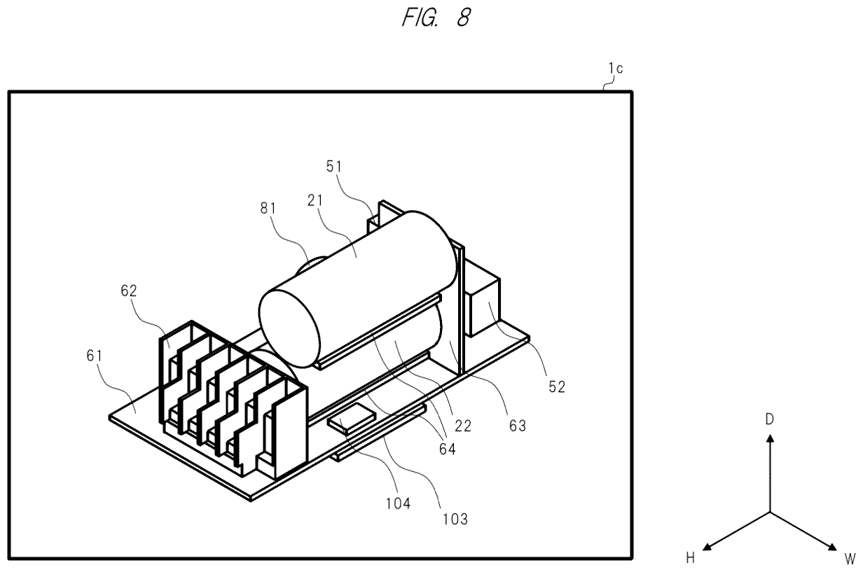

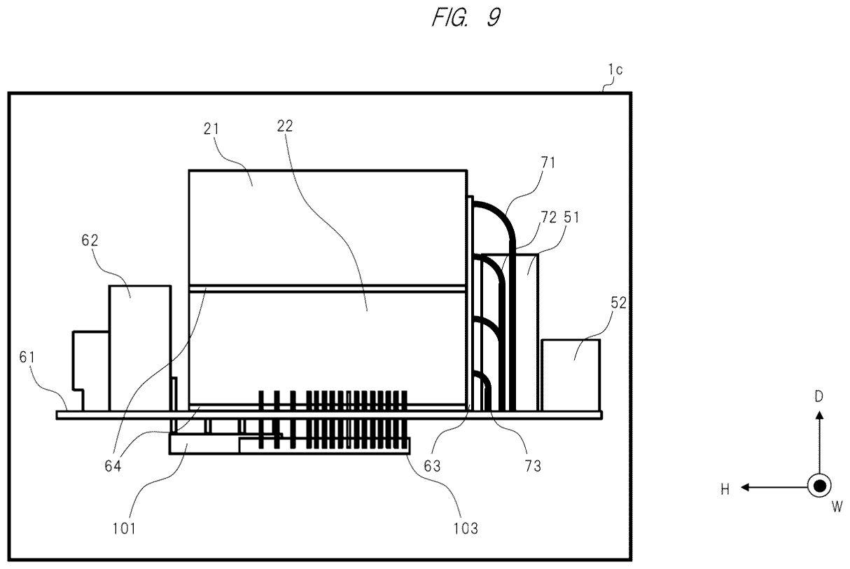

FIG. 8 is a bird's-eye view illustrating an example of an outer shape different from that in FIG. 5 in a power conversion device according to a third embodiment, and FIG. 9 is a side view, viewed in another direction, of the power conversion device illustrated in FIG. 8. In a power conversion device 1c illustrated in FIGS. 8 and 9, two bonding members 64 are added to the configuration example illustrated in FIG. 5. One of the two bonding members 64 physically bonds a smoothing capacitor 22 and a main circuit board 61 to each other, and the other of the two bonding members 64 physically bonds a smoothing capacitor 21 and the smoothing capacitor 22 to each other.

When respective positions of the smoothing capacitors 21 and 22 are defined via the main circuit board 61 and a capacitor board 63 by the system described in the second embodiment, for example, a gap may occur between the smoothing capacitor 22 and the main circuit board 61 or between the smoothing capacitor 21 and the smoothing capacitor 22 due to a dimensional tolerance. The gap may induce vibrations of the smoothing capacitors 21 and 22 when a product has vibrated during transportation or the like, for example. Accordingly, the smoothing capacitors 21 and 22 are desirably fixed to each other by filling the gap with an insulator.

Therefore, the power conversion device 1c illustrated in FIGS. 8 and 9 is configured to fill the gap by applying the bonding members 64 to the gap. An adhesive, an adhesive tape, curable rubber, and the like are specifically applicable as the bonding members 64.

### Main Effects of Third Embodiment

From the foregoing, a system according to the third embodiment is used, whereby similar effects to the various types of effects described in the second embodiment are obtained. Further, it is possible to more firmly fix the smoothing capacitors 21 and 22 to the main circuit board 61 by the bonding members 64.

### Fourth Embodiment

### <Outer Shape of Power Conversion Device>

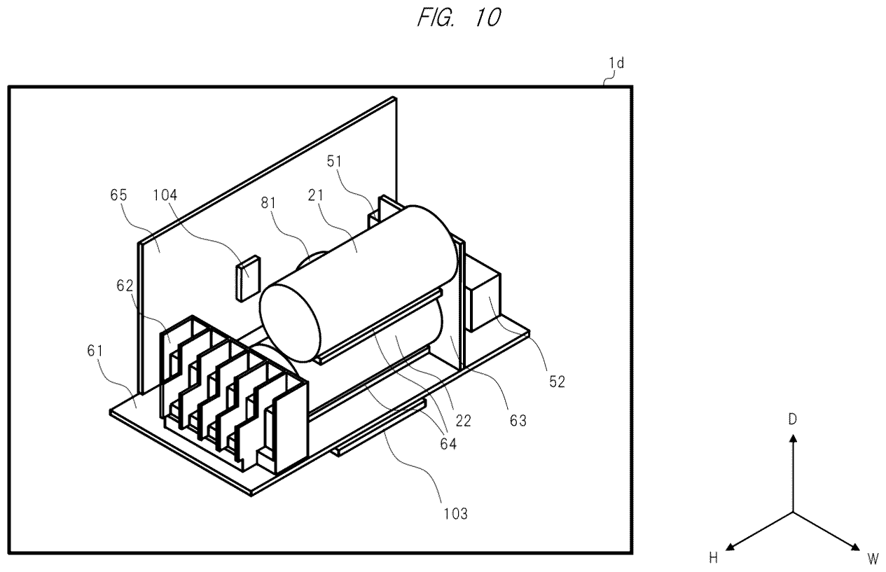

FIG. 10 is a bird's-eye view illustrating an example of an outer shape different from that in FIG. 8 in a power conversion device according to a fourth embodiment. In a power conversion device 1d illustrated in FIG. 10, a control board (third substrate) 65 to be electrically connected to a main circuit board 61 is added to the configuration example illustrated in FIG. 8. The control board 65 is arranged with a direction substantially perpendicular to a plane of the main circuit board 61 used as a plane direction, similarly to a capacitor board 63.

Specifically, the control board 65 is arranged on one surface of the main circuit board 61 in a direction substantially perpendicular to the capacitor board 63. That is, the plane direction of the control board 65 is a plane direction defined by a depth direction D and a height direction H, and a plane direction of the capacitor board 63 is a plane direction defined by the depth direction D and a width direction W. A control circuit 104 is mounted not on the main circuit board 61 as in the case of FIG. 8 but on the control board 65.

Accordingly, a smoothing capacitor 21 that outputs a high-side potential VP is arranged at a position farther away from the control board 65 on which the control circuit 104 is mounted than a smoothing capacitor 22 that outputs a low-side potential VN. In addition, a weak electric signal from the control circuit 104 or the like is also transmitted onto the main circuit board 61 via the control board 65. Accordingly, the smoothing capacitor 21 is arranged at a position farther away from the main circuit board 61 than the smoothing capacitor 22.

Here, the weak electric part described in the first embodiment is not limited to the control circuit 104, but may include, for example, various circuits depending on a function of the power conversion device, such as a communication circuit with an external interface, a power supply circuit for control, a functional safety circuit, and the like. If a mounting region of a weak electric part cannot be sufficiently secured in the main circuit board 61 as the function is thus added, it is beneficial not to increase the area of the main circuit board 61, i.e., the size thereof in the width direction W or the height direction H but to separately provide the control board 65 as illustrated in FIG. 10. In this case, for example, the control board 65 is responsible for a weak electric part, and the main circuit board 61 is responsible for a strong power part.

In the example illustrated in FIG. 10, the control board 65 extends in the same direction as a stacking direction of the smoothing capacitors 21 and 22, i.e., the depth direction D. Accordingly, an increase in the size of the power conversion device 1d can be suppressed. In addition, in this case, the size in the depth direction D of the control board 65 does not desirably exceed the size in the depth direction D of the stacked smoothing capacitors 21 and 22 as much as possible from the viewpoint of a device size.

Note that the control board 65 is arranged substantially perpendicularly to the main circuit board 61 in the example illustrated in FIG. 10, but is not limited to this. In some cases, the control board 65 may be arranged substantially, parallel to the main circuit board 61. In addition, the dimensions of the control board 65 depend on the specifications of the power conversion device, and are not limited to dimensions illustrated in FIG. 10.

### Main Effects of Fourth Embodiment

From the foregoing, a system according to the fourth embodiment is used, whereby similar effects to the various types of effects described in the third embodiment are obtained. Further, the control board 65 is provided, thereby making it possible to increase the mounting area of the weak electric part while suppressing the increase in the size of the power conversion device 1d. Moreover, the smoothing capacitor 21 is located away from the weak electric part, thereby making it possible to implement a stable operation of the power conversion device 1d.

Although the invention made by the inventors has been specifically described above based on the embodiments, the present invention is not limited to the above embodiments, but various modifications can be made without departing from the spirit and scope thereof. For example, the above embodiments have been described in detail to describe the present invention in an easy-to-understand manner, and are not necessarily limited to those including all described components. In addition, it is possible to replace some of the components in the certain embodiment with the components in the other embodiment and it is also possible to add, to the components in the certain embodiment, the components in the other embodiment. In addition, it is possible to add other components to, delete, and replace some of the components in each of the embodiments.

### EXPLANATION OF REFERENCE CHARACTERS

1, 1a to 1d power conversion device
101 rectifier circuit
103 inverter circuit
104 control circuit
21, 22 smoothing capacitor
61 main circuit board
63 capacitor board
64 bonding member
65 control board
71 to 73 electric wire
VP high-side potential
VN low-side potential

1. A power conversion device comprising:
a first capacitor that outputs a high-side potential of a DC voltage;
a second capacitor that is connected in series with the first capacitor and outputs a low-side potential of the DC voltage;
an inverter circuit that converts the DC voltage output from the first capacitor and the second capacitor into an AC voltage;
a control circuit that controls the inverter circuit; and
a first substrate on which the inverter circuit is mounted,
wherein each of the first capacitor and the second capacitor is arranged such that an axial direction, which defines its longest size, is substantially parallel to a plane direction of the first substrate, and
wherein the first capacitor is arranged at a position farther away from the control circuit than the second capacitor.

2. The power conversion device according to claim 1, further comprising
a rectifier circuit that is mounted on the first substrate and rectifies an external AC voltage and charges the first capacitor and the second capacitor,
wherein the first capacitor is charged in a positive half cycle of the external AC voltage, and
wherein the second capacitor is charged in a negative half cycle of the external AC voltage.

3. The power conversion device according to claim 1,
wherein the control circuit is mounted on the first substrate, and
wherein the first capacitor is arranged at a position farther away from the first substrate than the second capacitor.

4. The power conversion device according to claim 1,
wherein each of the first capacitor and the second capacitor has a positive electrode terminal and a negative electrode terminal on the same surface.

5. The power conversion device according to claim 4, further comprising
a second substrate arranged with a direction substantially perpendicular to a plane of the first substrate used as a plane direction,
wherein the first capacitor and the second capacitor are mounted on the second substrate.

6. The power conversion device according to claim 5,
wherein a protrusion is formed in the second substrate, and
wherein an opening, which is fitted in the protrusion, is formed in the first substrate.

7. The power conversion device according to claim 5,
wherein each of the positive electrode terminal and the negative electrode terminal of the first capacitor or the second capacitor is electrically connected to the first substrate via the second substrate and an electric wire.

8. The power conversion device according to claim 1,
wherein the first capacitor is physically bonded to the first substrate via a bonding member.

9. The power conversion device according to claim 1,
wherein the first capacitor and the second capacitor are physically bonded to each other via a bonding member.

10. The power conversion device according to claim 1, further comprising
a third substrate electrically connected to the first substrate,
wherein circuit is mounted on the third substrate, and
wherein the first capacitor is arranged at a position farther away from the third substrate than the second capacitor.

11. The power conversion device according to claim 10,
wherein the third substrate is arranged with a direction substantially perpendicular to a plane of the first substrate used as a plane direction.

12. The power conversion device according to claim 11,
wherein the first capacitor is arranged at a position farther away from the first substrate than the second capacitor.

13. The power conversion device according to claim 12, further comprising
a second substrate arranged with a direction substantially perpendicular to a plane of the first substrate as a plane direction,
wherein the first capacitor and the second capacitor are mounted on the second substrate.
